(19) United States
(12) Patent Application Publication
(10) Pub. No.: US 2025/0378985 A1
(43) Pub. Date: Dec. 11, 2025

(54) REACTOR, MAGNETIC CORE, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Toru SHIMIZU, Mie (JP); Kazushi KUSAWAKE, Mie (JP)

(21) Appl. No.: 18/878,661

(22) PCT Filed: Jun. 28, 2023
(86) PCT No.: PCT/JP2023/024029

§ 371 Date: Dec. 24, 2024

(30) Foreign Application Priority Data
Jun. 29, 2022 (JP) 2022-105129

(51) Int. Cl. H01F 27/28; H01F 27/24; H02M 7/537

(52) U.S. Cl. CPC H01F 27/28; H01F 27/24; H02M 7/537

(57) ABSTRACT

This reactor comprises: a magnetic core including a core portion which is configured in a prismatic shape; and a coil which includes a first winding portion disposed on the outer periphery of the core portion, and a second winding portion disposed on the outer periphery of the first winding portion. The first winding portion is composed of a first winding wire which is spirally wound along the outer peripheral surface of the core portion. The second winding portion is composed of a second winding wire which is wound along the outer peripheral surface of the first winding portion. The first winding wire and the second winding wire are continuous winding wires. The number of turns of the first winding portion is less than the number of turns of the second winding portion. The outer peripheral surface of the core portion includes a first plane having a plurality of groove portions arranged in a direction along the axis of the core portion. Parts of the first winding wire in each turn of the first winding portion are disposed in respective ones of the plurality of groove portions.

### TECHNICAL FIELD

The present disclosure relates to a reactor, a magnetic core, a converter and a power conversion device.

This application claims a priority based on Japanese Patent Application No. 2022-105129 filed on Jun. 29, 2022, all the contents of which are hereby incorporated by reference.

### BACKGROUND

A reactor of Patent Document 1 is provided with a coil and a magnetic core. The coil includes a pair of winding portions formed by helically winding a winding wire. Each winding portion has an angular tube shape. The magnetic core includes a pair of inner core portions and a pair of outer core portions. Each inner core portion is arranged inside each winding portion. Each inner core portion has an angular prism shape. Each outer core portion is arranged outside the both winding portions.

### PRIOR ART DOCUMENT

### Patent Document

Patent Document 1: JP 2013-219318 A

### SUMMARY OF THE INVENTION

A reactor of the present disclosure is provided with a magnetic core including a core portion configured into an angular prism shape and a coil including a first winding portion arranged an outer periphery of the core portion and a second winding portion arranged on an outer periphery of the first winding portion, the first winding portion being formed by a first winding wire helically wound along an outer peripheral surface of the core portion, the second winding portion being formed by a second winding wire helically wound along an outer peripheral surface of the first winding portion, the first winding wire and the second winding wire constituting a continuous winding wire, a turn number of the first winding portion is less than a turn number of the second winding portion, the outer peripheral surface of the core portion including a first flat surface having a plurality of groove portions arranged in a direction along an axis of the core portion, and a part of the first winding wire in each turn of the first winding portion being arranged in each of the plurality of groove portions.

A magnetic core of the present disclosure is provided with a core portion having an angular prism shape, an outer peripheral surface of the core portion including a first flat surface having a plurality of groove portions arranged in a direction along an axis of the core portion.

A converter of the present disclosure is provided with the reactor of the present disclosure.

A power conversion device of the present disclosure is provided with the converter of the present disclosure.

### BRIEF DESCRIPTION OF THE DRAWINGS

FIG. 1 is a schematic perspective view showing a reactor of a first embodiment.

FIG. 2 is a schematic exploded perspective view showing the reactor of the first embodiment.

FIG. 3 is a section along III-III of FIG. 1.

FIG. 4 is an enlarged view of a region A of FIG. 3.

FIG. 5 is an enlarged view showing other examples of groove portions and a first winding wire in the reactor of the first embodiment.

FIG. 6 is an enlarged view showing still other examples of the groove portions and the first winding wire in the reactor of the first embodiment.

FIG. 7 is an enlarged view showing groove portions and a first winding wire in a reactor of a second embodiment.

FIG. 8 is an enlarged view showing groove portions and a first winding wire in a reactor of a third embodiment.

FIG. 9 is an enlarged view showing groove portions and a first winding wire in a reactor of a fourth embodiment.

FIG. 10 is an enlarged view showing groove portions and a first winding wire in a reactor of a fifth embodiment.

FIG. 11 is an enlarged view showing other examples of the groove portions and the first winding wire in the reactor of the fifth embodiment.

FIG. 12 is a configuration diagram schematically showing a power supply system of a hybrid vehicle.

FIG. 13 is a circuit diagram showing an example of a power conversion device provided with a converter.

### DETAILED DESCRIPTION TO EXECUTE THE INVENTION

### Technical Problem

It is desired to easily enhance heat dissipation and, moreover, suppress the enlargement of a reactor and a reduction of a magnetic path area while increasing a turn number.

The reactor of Patent Document 1 is manufactured as follows. The pair of winding portions are prepared. Each inner core portion is inserted inside each winding portion. The both inner core portions and the both outer core portions are fixed. To insert each inner core portion inside each winding portion, a gap is provided between the inner peripheral surface of each winding portion and the outer peripheral surface of each inner core portion. By providing the gap, it is difficult to improve heat dissipation of the inner core portion.

It is thought to make each winding portion have not a single layer structure, but a double layer structure on inner and outer sides to increase the turn number. If a cross-sectional area of the inner core portion is fixed, a reactor provided with a winding portion having the double layer structure has a larger size than a reactor provided with a winding portion having a single layer structure. The cross-sectional area of the inner core portion is an area of a cross-section orthogonal to a direction along an axis of the inner core portion. If an outer diameter of the winding portion is fixed, the reactor provided with the winding portion having the double layer structure has a smaller cross-sectional area of the inner core portion than the reactor provided with the winding portion having the single layer structure, wherefore a magnetic path area is reduced.

One object of the present disclosure is to provide a reactor easily enhancing heat dissipation and, moreover, easily suppressing enlargement and a reduction of a magnetic path area while increasing a turn number. Another object of the present disclosure is to provide a magnetic core capable of constructing a reactor easily enhancing heat dissipation and, moreover, easily suppressing enlargement and a reduction of a magnetic path area while increasing a turn number. Still another object of the present disclosure is to provide a converter provided with the above reactor and a power conversion device provided with the above converter.

### Effect of Present Disclosure

The reactor of the present disclosure easily enhances heat dissipation and, moreover, easily suppresses enlargement and a reduction of a magnetic path area while increasing a turn number. The magnetic core of the present disclosure easily constructs a reactor easily enhancing heat dissipation and, moreover, easily suppressing enlargement and a reduction of a magnetic path area while increasing a turn number. The converter of the present disclosure and the power conversion device of the present disclosure are excellent in heat dissipation without being enlarged.

### Description of Embodiments of Present Disclosure

First, embodiments of the present disclosure are listed and described.

(1) A reactor according to one aspect of the present disclosure is provided with a magnetic core including a core portion configured into an angular prism shape and a coil including a first winding portion arranged an outer periphery of the core portion and a second winding portion arranged on an outer periphery of the first winding portion, the first winding portion being formed by a first winding wire helically wound along an outer peripheral surface of the core portion, the second winding portion being formed by a second winding wire helically wound along an outer peripheral surface of the first winding portion, the first winding wire and the second winding wire constituting a continuous winding wire, a turn number of the first winding portion is less than a turn number of the second winding portion, the outer peripheral surface of the core portion including a first flat surface having a plurality of groove portions arranged in a direction along an axis of the core portion, and a part of the first winding wire in each turn of the first winding portion being arranged in each of the plurality of groove portions.

The configuration of (1) described above more easily enhances heat dissipation than the conventional reactor. In the configuration of (1) described above, the first winding portion is along the outer peripheral surface of the core portion and the part of the first winding wire in each turn of the first winding portion is arranged in each of the plurality of groove portions provided in the core portion. That is, in the configuration of (1) described above, a contact area of the first winding wire and the core portion is easily increased. On the other hand, a gap is provided between the inner peripheral surface of the winding portion and the outer peripheral surface of the core portion in the conventional reactor. That is, the winding portion and the core portion are not in contact in the conventional reactor. Thus, the configuration of (1) described above more easily transfers heat of the coil to the core portion than the conventional reactor.

In the configuration of (1) described above, the turn number can be increased since the coil includes the first winding portion. Thus, the configuration of (1) described above has an excellent inductance.

Since the part of the first winding wire in each turn of the first winding portion is arranged in each of the plurality of groove portions provided in the core portion in the configuration of (1) described above, enlargement is less likely as compared to the case where the groove portions are not provided. If an outer diameter of the second winding portion is fixed, a reduction in the cross-sectional area of the core portion is only an amount equivalent to the cross-sectional area of the groove portion in the configuration of (1) described above, wherefore a reduction of a magnetic path area is easily suppressed.

The configuration of (1) described above is easily manufactured. This is because the first winding portion can be fabricated by winding the first winding wire along the groove portions along the outer peripheral surface of the core portion. That is, when the first winding portion is fabricated, the groove portions can be used as guides for the first winding wire.

(2) In the reactor of (1) described above, the outer peripheral surface of the core portion may include a helical groove provided coaxially with the core portion, each of the plurality of groove portions may constitute a part of the helical groove, and the first winding wire in all the turns of the first winding portion may be arranged in the helical groove.

Since the contact area of the first winding wire and the core portion is easily increased in the configuration of (2) described above, heat of the first winding wire is easily transferred to the core portion. Thus, the configuration of (2) described above easily enhances heat dissipation.

(3) In the reactor of (1) or (2) described above, a depth of each of the plurality of groove portions may be equal to a length along a direction of the depth in a cross-section of the first winding wire.

The configuration of (3) described above more easily transfers heat of the first winding wire to the core portion than the configuration of (4) to be described later. The reason for that is that the contact area of the first winding wire and the core portion tends to be larger in the configuration of (3) described above than in the configuration of (4) to be described later. Further, the configuration of (3) described above more easily transfers heat of the second winding wire to the core portion than the configuration of (4) to be described later. The reason for that is as follows. In the configuration of (3) described above, the first winding wire arranged in the groove portions does not project from the groove portions. On the other hand, in the configuration of (4) to be described later, the first winding wire arranged in the groove portions partially projects from the groove portions. Thus, a contact area of the second winding wire and ridges of the core portion in the configuration of (3) described above tends to be larger than in the configuration of (4) to be described later. The ridges are parts between the groove portions adjacent in the direction along the axis, out of the outer peripheral surface of the core portion. Therefore, the configuration of (3) described above is excellent in heat dissipation since heat of the first and second winding wires is easily transferred to the core portion.

(4) In the reactor of (1) or (2) described above, a depth of each of the plurality of groove portions may be smaller than a length along a direction of the depth in a cross-section of the first winding wire.

The configuration of (4) described above is more easily manufactured than the configuration of (3) described above. The reason for that is that steps between parts of the first winding wire projecting from the groove portions and the ridges are easily used as guides in the configuration of (4) described above when the second winding wire is wound in a manufacturing process.

(5) In the reactor of (1) or (2) described above, a depth of each of the plurality of groove portions may be larger than a length along a direction of the depth in a cross-section of the first winding wire.

Similarly to the configuration of (3) described above, the configuration of (5) described above more easily transfers heat of the first and second winding wires to the core portion than the configuration of (4) described above. Thus, the configuration of (5) described above is excellent in heat dissipation.

(6) In the reactor of any one of (1) to (5) described above, the first winding wire and the second winding wire may be rectangular wires, and a cross-sectional shape of each of the plurality of groove portions cut along the axis of the core portion may be a rectangular shape.

Since the first winding wire is easily arranged in the groove portions in the configuration of (6) described above, the first winding wire and the groove portions are easily brought into contact. Thus, the configuration of (6) described above easily transfers heat of the first winding wire to the core portion.

(7) In the reactor of (6) described above, the first winding portion and the second winding portion may be formed by winding the rectangular wire flatwise.

Since the rectangular wire is more easily bent in the configuration of (7) described above than in the configuration of (8) to be described later, the first and second winding portions are easily fabricated.

(8) In the reactor of (6) described above, the first winding portion and the second winding portion may be formed by winding the rectangular wire edgewise.

If a length in the direction along the axis of the winding portion is fixed, the turn numbers of the first and second winding portions are more easily increased in the configuration of (8) described above than in the configuration of (7) described above. If the turn numbers of the first and second winding wires are fixed, lengths in the direction along the axis of the first and second winding portions are more easily shortened in the configuration of (8) described above than in the configuration of (7) described above. Thus, the configuration of (8) described above is more easily reduced in size than the configuration of (7) described above.

(9) In the reactor of any one of (1) to (8) described above, the core portion may have a rectangular prism shape, and the first winding portion and the second winding portion may have a rectangular tube shape.

The configuration of (9) described above is easily manufactured since the first winding wire is easily wound along the outer peripheral surface of the core portion in the manufacturing process. In the configuration of (9) described above, a contact area of the second winding wire and an installation target of the reactor is easily increased as compared to the case where the second winding wire has a circular tube shape having the same cross-sectional area. Thus, the configuration of (9) described above easily transfers heat of the second winding portion to the installation target. Moreover, the second winding portion is easily stably installed on the installation target in the configuration of (9) described above.

(10) In the reactor of any one of (1) to (9) described above, the core portion may include a core body portion mainly containing a magnetic material and an insulating portion provided along an outer peripheral surface of the core body portion, and the plurality of groove portions may be provided in the insulating portion.

The configuration of (10) described above easily enhances insulation between the core body portion and the coil by the insulating portion as compared to the case where the core portion is composed only of the core body portion without including the insulating portion.

(11) A magnetic core according to one aspect of the present disclosure is provided with a core portion having an angular prism shape, an outer peripheral surface of the core portion including a first flat surface having a plurality of groove portions arranged in a direction along an axis of the core portion.

The configuration of (11) described above facilitates the construction of a reactor easily enhancing heat dissipation and, moreover, easily suppressing enlargement and a reduction of a magnetic path area while increasing a turn number for the reasons described in (1) described above.

(12) In the magnetic core of (11) described above, the outer peripheral surface of the core portion may include a helical groove provided coaxially with the core portion, and each of the plurality of groove portions may constitute a part of the helical groove.

The configuration of (12) described above facilitates the construction of a reactor easily enhancing heat dissipation for the reasons described in the configuration of (2) described above.

(13) A converter according to one aspect of the present disclosure is provided with the reactor of any one of (1) to (10) described above.

The above converter is excellent in heat dissipation without being enlarged since being provided with the above reactor.

(14) A power conversion device according to one aspect of the present disclosure is provided with the converter of (13) described above.

The above power conversion device is excellent in heat dissipation without being enlarged since being provided with the above converter.

### Details of Embodiments of Present Disclosure

Embodiments of the present disclosure are described in detail below with reference to the drawings. The same reference signs in figures denote the same components. The size and the like of a member shown in each figure are expressed for the purpose of clarifying description, and do not necessarily represent an actual dimensional relationship and the like.

### First Embodiment

### Reactor

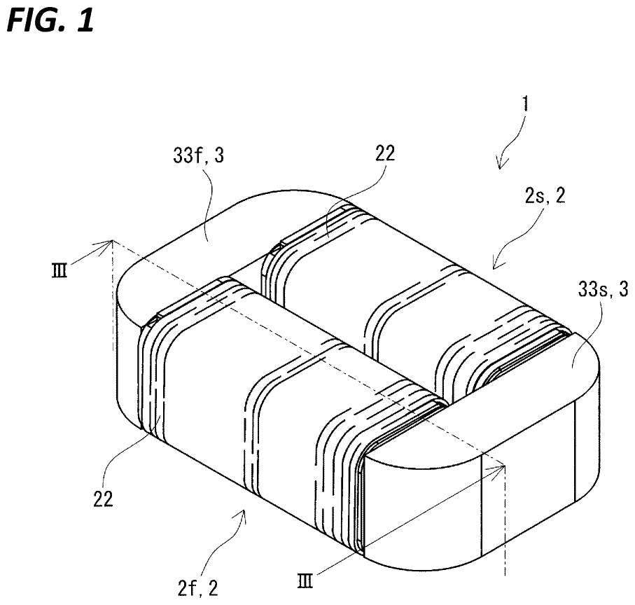

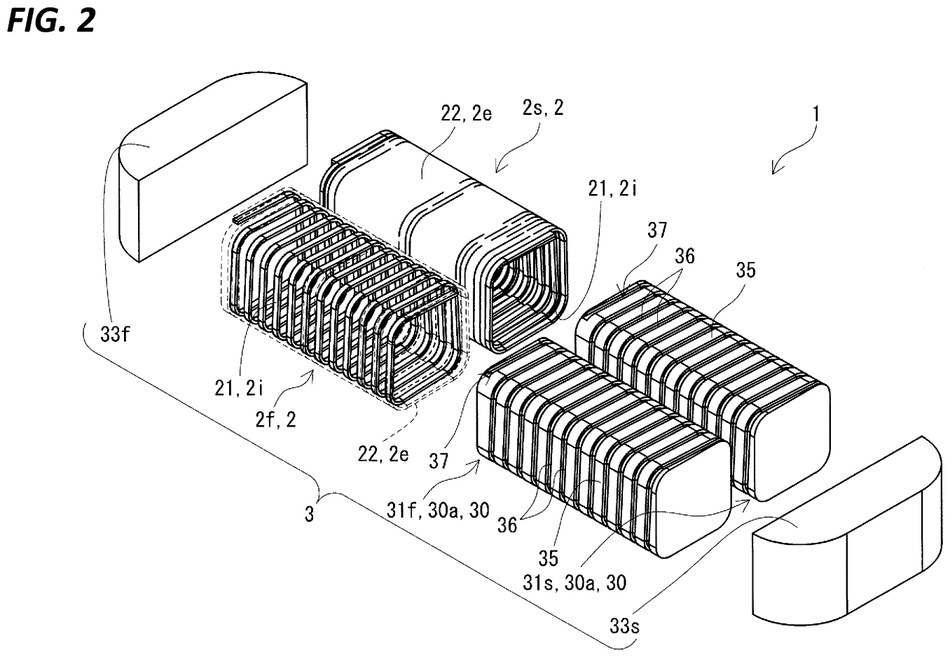

A reactor 1 of a first embodiment is described with reference to FIGS. 1 to 6. The reactor 1 is provided with coils 2 and a magnetic core 3. As shown in FIG. 2, the magnetic core 3 includes core portions 30. The core portion 30 has an angular prism shape. The coil 2 includes a first winding portion 2i and a second winding portion 2e. The first winding portion 2i is arranged on the outer periphery of the core portion 30. The second winding portion 2e is arranged on the outer periphery of the first winding portion 2i. One of features of the reactor 1 of this embodiment is to satisfy the following requirements (A) to (C).

(A) As shown in FIG. 2, the outer peripheral surface of the core portion 30 includes a first flat surface 35. The first flat surface 35 includes a plurality of groove portions 36 arranged in a direction along an axis of the core portion 30.

(B) The first winding portion 2i is formed by a first winding wire 21. The first winding wire 21 is helically wound along the outer peripheral surface of the core portion 30.

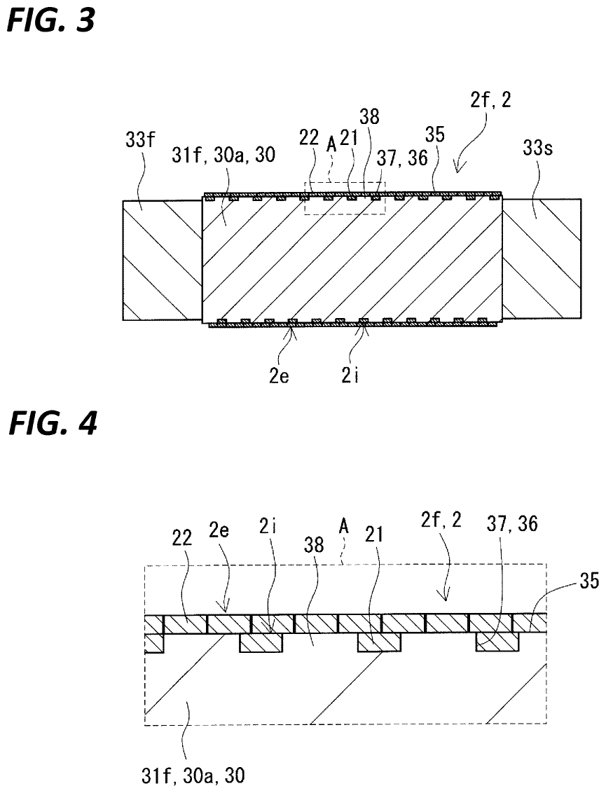

(C) As shown in FIGS. 3 and 4, a part of the first winding wire 21 in each turn of the first winding portion 2i is arranged in each of the plurality of groove portions 36.

### Magnetic Core

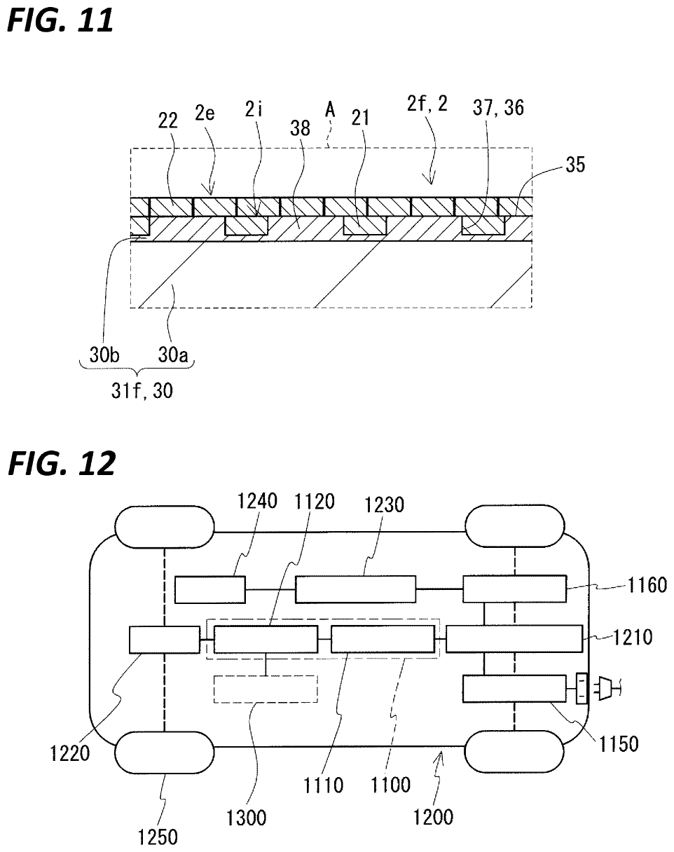

The magnetic core 3 of this embodiment shown in FIG. 2 includes a first middle core portion 31f and a second middle core portion 31s, a first end core portion 33f and a second end core portion 33s. The core portion 30 of this embodiment constitutes each of the first and second middle core portions 31f, 31s. Each of the core portions 30 of this embodiment, i.e. the first and second middle core portions 31f, 31s, does not include an insulating portion 30b to be described later with reference to FIGS. 10 and 11 unlike a fifth embodiment, and is constituted by a core body portion 30a mainly containing a magnetic material. The core body portion 30a is constituted by a molded body or a laminated body to be described later. Each of the first and second end core portions 33f, 33s is constituted by a molded body or a laminated body independent of the first and second middle core portions 31f, 31s.

The first and second middle core portions 31f, 31s and the first and second end core portions 33f, 33s are combined into an annular shape. A first end surface of the first middle core portion 31f and an inner end surface of the first end core portion 33f are facing each other. A second end surface of the first middle core portion 31f and an inner end surface of the second end core portion 33s are facing each other. A first end surface of the second middle core portion 31s and the inner end surface of the first end core portion 33f are facing each other. A second end surface of the second middle core portion 31s and the inner end surface of the first end core portion 33f are facing each other. Gap members to be described later are arranged between the first middle core portion 31f and the first end core portion 33f, between the first middle core portion 31f and the second end core portion 33s, between the second middle core portion 31s and the first end core portion 33f and between the second middle core portion 31s and the second end core portion 33s.

The first and second middle core portions 31f, 31s have the same configuration. The first and second end core portions 33f, 33s have the same configuration. The first middle core portion 31f and the first end core portion 33f are described as representatives below.

The first middle core portion 31f has an angular prism shape. The first middle core portion 31f of this embodiment has a rectangular prism shape. Four corner parts of the rectangular prism shape are rounded. That is, an outer peripheral surface of the first middle core portion 3 1f except the first and second end surfaces is composed of four flat surfaces and four corner parts.

As shown in FIG. 2, out of the four flat surfaces, at least one flat surface is the aforementioned first flat surface 35. For example, one flat surface may be the first flat surface 35 and the remaining three flat surfaces may be second flat surfaces. The second flat surface is a planar surface not provided with the groove portions 36, unlike the first flat surface 35. In this case, out of the four flat surfaces, the flat surface facing an installation target of the reactor 1 may be the first flat surface 35. For example, out of the four flat surfaces, two flat surfaces may be the first flat surfaces 35 and the remaining two flat surfaces may be the second flat surfaces. In this case, the first flat surfaces 35 and the second flat surfaces may be alternately arranged in a direction about an axis of the first middle core portion 31f. That is, the first flat surfaces 35 may be provided at positions facing each other. For example, all the four flat surfaces may be the first flat surfaces 35. In this embodiment, all the four flat surfaces are the first flat surfaces 35.

The outer peripheral surface of the first middle core portion 31f of this embodiment includes one helical groove 37 provided coaxially with the first middle core portion 31f. If the outer peripheral surface of the first middle core portion 31f includes the helical groove 37 as in this embodiment, each of the four corner parts also includes a plurality of groove portions 36 arranged in the direction along the axis. Each of the plurality of groove portions 36 provided in each first flat surface 35 and each of the plurality of groove portions 36 provided in each corner part constitute parts of the helical groove 37. The groove portions 36 of the adjacent first flat surface 35 and corner part are continuous with each other. If only the first flat surface 35 or the corner part is focused, the plurality of groove portions 36 are provided since the groove portions 36 are independent of each other. If the entire outer peripheral surface of the first middle core portion 31f is focused, one helical groove 37 is provided since the helical groove 37 is one continuous groove. The helical groove 37 of this embodiment is shifted by ¼ pitch for each ¼ turn.

A cross-sectional shape of each groove portion 36 cut along the axis can be appropriately selected according to a cross-sectional shape of the first winding wire 21. The cross-sectional shape of this embodiment is a rectangular shape.

As shown in FIGS. 3 and 4, a width of each groove portion 36 is substantially equal to that of the first winding wire 21, which is a rectangular wire in this embodiment. The width of the groove portion 36 is a length along a direction orthogonal to an extension direction of the groove portion 36 and a depth direction of the groove portion 36. Since the width of each groove portion 36 is substantially equal to that of the first winding wire 21, a contact area of the first winding wire 21 arranged in each groove portion 36 and the first middle core portion 31f tends to be large. Thus, heat of the first winding wire 21 is easily transferred to the first middle core portion 31f. Thus, the reactor 1 is excellent in heat dissipation.

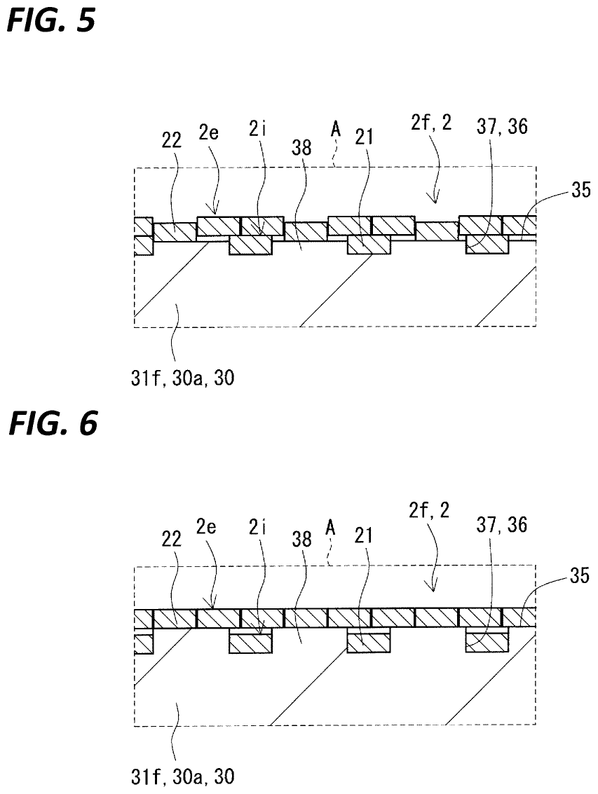

As shown in FIG. 4, a depth of each groove portion 36 may be equal to a length along the depth direction in the cross-section of the first winding wire 21 along the axis, i.e. a thickness of the first winding wire 21, which is a coated rectangular wire in this embodiment. The depth of each groove portion 36 may be smaller than the thickness of the first winding wire 21 as shown in FIG. 5. The depth of each groove portion 36 may be larger than the thickness of the first winding wire 21 as shown in FIG. 6.

A contact area of the first winding wire 21 and the first middle core portion 31f tends to be larger in examples shown in FIGS. 4 and 6 than in an example shown in FIG. 5. Thus, in the examples shown in FIGS. 4 and 6, heat of the first winding wire 21 is more easily transferred to the first middle core portion 31f than in the example shown in FIG. 5. In the examples shown in FIGS. 4 and 6, the first winding wire 21 arranged in the groove portions 36 do not project from the groove portions 36. On the other hand, in the example shown in FIG. 5, the first winding wire 21 arranged in the groove portions 36 partially projects from the groove portions 36. Thus, contact areas of the second winding wire 21 and ridges 38 of the first middle core portion 31f in the examples shown in FIGS. 4 and 6 tend to be larger than in the example shown in FIG. 5. The ridge 38 is a part between the groove portions 36 in adjacent turns in the direction along the axis of the helical groove 37, out of the outer peripheral surface of the first middle core portion 31f. Thus, in the examples shown in FIGS. 4 and 6, heat of the second winding wire 21 is also more easily transferred to the first middle core portion 31f than in the example shown in FIG. 5. Further, the outer peripheral surface of the second winding portion 2e is more easily made flush in the examples shown in FIGS. 4 and 6 than in the example shown in FIG. 5. Thus, the outer peripheral surface of the second winding portion 2e and the installation target are more easily brought into surface contact in the examples shown in FIGS. 4 and 6 than in the example shown in FIG. 5. An example of the installation target is a cooling base or the inner surface of a case. Thus, heat of the second winding wire 22 is also more easily transferred to the installation target in the examples shown in FIGS. 4 and 6 than in the example shown in FIG. 5. In the example shown in FIG. 5, steps between parts of the first winding wire 21 projecting from the groove portions 36 and the ridges 38 are more easily used as guides than in the examples shown in FIGS. 4 and 6 in a manufacturing process. Thus, the example shown in FIG. 5 is more easily manufactured than the examples shown in FIGS. 4 and 6.

An interval between the groove portions 36 in the adjacent turns in the direction along the axis in the helical groove 37 can be appropriately selected. The interval between the groove portions 36 is a shortest distance between openings of the groove portions 36. The interval between the groove portions 36 may be equal to or smaller or larger than the length of the groove portion 36 along the axis. The smaller the interval between the groove portions 36, the larger a turn number of the first winding portion 2i. The larger the interval between the groove portions 36, the smaller the turn number of the first winding portion 2i. Thus, a magnetic path area is easily ensured. Moreover, a turn number of the second winding portion 2e in contact with the ridges 38 of the first middle core portion 31f tends to increase. Therefore, heat of the second winding wire 22 is easily transferred to the first middle core portion 31f.

The first end core portion 33f has a prism shape. The first end core portion 33f of this embodiment has a prism shape having substantially dome-shaped upper and lower surfaces.

The first middle core portion 31f and the first end core portion 33f are each constituted by a compact of a composite material, a powder compact or a laminated body.

The compact of the composite material is a compact in which a soft magnetic powder is dispersed in a resin. The compact of the composite material is obtained by filling a fluid raw material, in which the soft magnetic powder is dispersed in the non-solidified resin, into a mold and solidifying the resin. The compact of the composite material formed with the plurality of groove portions 36 or the helical groove 37 can be fabricated by the transfer of the mold. The compact of the composite material can easily adjust a content of the soft magnetic powder in the resin. Thus, the compact of the composite material easily adjusts magnetic properties. Moreover, the compact of the composite material is more easily formed even into a complicated shape than the powder compact. The content of the soft magnetic powder in the compact of the composite material is, for example, 20% by volume or more and 80% by volume or less. A content of the resin in the compact of the composite material is, for example, 20% by volume or more and 80% by volume or less. These contents are values when the compact of the composite material is 100% by volume.

The powder compact is a compact fabricated by compression-forming the soft magnetic powder. The powder compact is obtained by filling the soft magnetic powder into a cavity and pressing the soft magnetic powder in the cavity by a punch. The powder compact provided with the plurality of groove portions 36 can be fabricated by the transfer of at least one of the cavity and the punch. The powder compact can increase a ratio of the soft magnetic powder in the core portion 30 as compared to the compact of the composite material. Thus, the powder compact easily enhances magnetic properties. The magnetic properties include a relative magnetic permeability and a saturation magnetic flux density. Further, the powder compact is excellent in heat dissipation since containing more soft magnetic powder than the compact of the composite material. A content of the soft magnetic powder in the powder compact is, for example, 85 by volume or more and 99 by volume or less. This content is a value when the powder compact is 100% by volume.

Particles constituting the soft magnetic powder are particles or coated particles of soft magnetic metal, particles of soft nonmagnetic metal or the like. The coated particle may include a particle of soft magnetic metal and an insulation coating provided on the outer periphery of the particle of soft magnetic metal. The soft magnetic metal is a pure iron, an iron-based alloy or the like. The iron-based alloy is, for example, a Fe (iron)-Si (silicon) alloy or a Fe—Ni (nickel) alloy. An example of the insulation coating is phosphate. An example of the soft nonmagnetic metal is ferrite.

The resin of the compact of the composite material is, for example, a thermosetting resin or a thermoplastic resin. The thermosetting resin is, for example, an epoxy resin, a phenol resin, a silicone resin or a urethane resin. The thermoplastic resin is, for example, a polyphenylene sulfide resin, a polyamide resin, a liquid crystal polymer (LCP), a polyimide resin or a fluororesin. The polyamide resin is, for example, nylon 6, nylon 66 or nylon 9T.

The compact of the composite material may contain a filler. The filler is, for example, alumina or silica. The filler contributes to improving heat dissipation and electrical insulation.

The content of the soft magnetic powder in the compact of the composite material and the content of the soft magnetic powder in the powder compact are regarded as equivalent to area ratios of the soft magnetic powder in cross-sections of the compacts. The content of the soft magnetic powder in the compact is obtained as follows. The cross-section of the compact is observed by a SEM (scanning electron microscope) and observation images are obtained. The cross-section of the compact is an arbitrary cross-section. A magnification of the SEM is, for example, set to 200× or more and 500× or less. The number of the obtained observation images is 10 or more. A total area of all the observation images is set to 0.1 cm² or more. One observation image may be obtained for one cross-section or a plurality of observation images may be obtained for one cross-section. An image processing is applied to each obtained observation image to extract the contours of the particles of the soft magnetic powder. The image processing is, for example, a binarization processing. A area ratio of the soft magnetic particles in each observation image is calculated, and an average value of those area ratios is obtained. That average value is regarded as the content of the soft magnetic powder.

The laminated body is formed by laminating a plurality of magnetic thin plates. The magnetic thin plate includes an insulation coating. The magnetic thin plate is, for example, an electromagnetic copper plate. The laminated body provided with the plurality of groove portions 36 or the helical groove 37 can be fabricated by laminating the plurality of magnetic thin plates having different areas along a direction along the thicknesses of the magnetic thin plates.

The first middle core portion 31f, the second middle core portion 31s, the first end core portion 33f and the second end core portion 33s of this embodiment are constituted by the compacts of the composite materials.

### Gap Member

The gap member is constituted by a member made of a material having a smaller relative magnetic permeability than the first middle core portion 31f, the second middle core portion 31s, the first end core portion 33f and the second end core portion 33s. A constituent material of the gap member is, for example, the ceramic or the resin described above.

### Coil

The coils 2 of this embodiment shown in FIG. 2 include a first coil 2f and a second coil 2s. The first and second coils 2f, 2s may or may not be connected to each other. The first and second winding portions 2i, 2e are respectively provided in the first and second coils 2f, 2s. The first winding portion 2i of the first coil 2f is arranged on the outer periphery of the first middle core portion 31f. The second winding portion 2e of the first coil 2f is arranged on the outer periphery of the first winding portion 2i of the first coil 2f. For the convenience of description, the second winding portion 2e of the first coil 2f is shown by two-dot chain lines in FIG. 2. The second winding portion 2e of the second coil 2s is arranged on the outer periphery of the second middle core portion 31s. The second winding portion 2e of the second coil 2s is arranged on the outer periphery of the first winding portion 2i of the second coil 2f. The first and second coils 2f, 2s include the first winding portion 2i, whereby a turn number increases. Thus, the reactor 1 has an excellent inductance. The first and second winding portions 2i, 2e of the first coil 2f and those of the second coil 2s have the same configurations. The first and second winding portions 2i, 2e of the first coil 2f are described as representatives below.

The first winding portion 2i has a rectangular tube shape. Corner parts of the first winding portion 2i are rounded. The first winding portion 2i is formed by the first winding wire 21. The first winding wire 21 is helically wound along the outer peripheral surface of the first middle core portion 31f. The first winding portion 2i having a rectangular tube shape is easily manufactured since the first winding wire 21 is easily wound along the outer peripheral surface of the first middle core portion 31f in the manufacturing process. The trace of the first winding wire 21 of each turn is along each groove portion 36. The first winding wire 21 is arranged in the helical groove 37. Thus, heat of the first winding wire 21 is easily transferred to the first middle core portion 31f. Thus, the reactor 11 is excellent in heat dissipation. The turn number of the first winding portion 2i and that of the helical groove 37 are equal. The turn number of the first winding portion 2i is less than that of the second winding portion 2e. By reducing the turn number of the first winding portion 2i, the turn number of the helical groove 37 is small. Thus, a reduction in magnetic path area can be suppressed. The pitch of the first winding portion 2i can be appropriately selected. The pitch is an interval between the turns along the width of the first winding wire 21. The pitch may be equal to the width of the first winding wire 21 or may be smaller or larger than the width of the first winding wire 21.

The second winding portion 2e has a rectangular tube shape. Corner parts of the second winding portion 2e are rounded. Since the second winding portion 2e has a rectangular tube shape, a contact area of the second winding portion 2e and the installation target is easily increased as compared to the case where the second winding portion 2e has a circular tube shape having the same cross-sectional area. Thus, heat of the second winding portion 2e is easily transferred to the installation target. Moreover, the second winding portion 2e is easily stably installed on the installation target. The second winding portion 2e is formed by the second winding wire 22. The second winding wire 22 is wound along the outer peripheral surfaces of the first winding portion 2i and the first middle core portion 31f. The first winding wire 21 and the second winding wire 22 constitute a continuous winding wire. That is, the second winding wire 22 and the first winding wire 11 constitute one winding wire with no joint present therebetween. Substantially no gaps are formed between the turns of the second winding portion 2e. The adjacent turns of the second winding portion 2e are in contact with each other. Since the turn number of the second winding portion 2e is more than that of the first winding portion 2i, the second winding portion 2e are partially held in contact with the ridges 38 of the first middle core portion 31f. Thus, heat of the second winding portion 2e is also easily transferred to the first middle core portion 31f.

Known winding wires can be utilized as the first and second winding wires 21, 22. The first and second winding wires 21, 22 of this embodiment are coated rectangular wires. Since the coated rectangular wire is easily arranged in the groove portions 36, the first winding wire 21 and the groove portions 36 are easily brought into contact. Thus, heat of the first winding wire 21 is easily transferred to the first middle core portion 31f. A conductor wire of the coated rectangular wire is constituted by a rectangular wire made of copper. An insulation coating of the coated rectangular wire is made of enamel. The first and second winding portions 2i, 2e are formed by winding the coated rectangular wire flatwise. The first and second winding portions 2i, 2e wound flatwise are easily fabricated due to the easily bent coated rectangular wire as compared to the first and second winding portions 2i, 2e wound edgewise.

The first winding portion 2i is fabricated by winding the first winding wire 21 along the helical groove 37 of the first middle core portion 31f. The second winding portion 2e is fabricated by winding the second winding wire 22 along the outer peripheral surfaces of the first middle core portion 31f and the first winding portion 2i. The first winding wire 21 is wound from a first end part toward a second end part of the first middle core portion 31f. The second winding wire 22 is wound from the second end part toward the first end part. The first and second winding wires 21, 22 are connected at the second end part.

### Other Embodiments

Reactors of second to sixth embodiments different from the first embodiment are described. The description of the second to sixth embodiments is centered on points of difference from the first embodiment. The configuration similar to that of the first embodiment may not be described.

### Second Embodiment

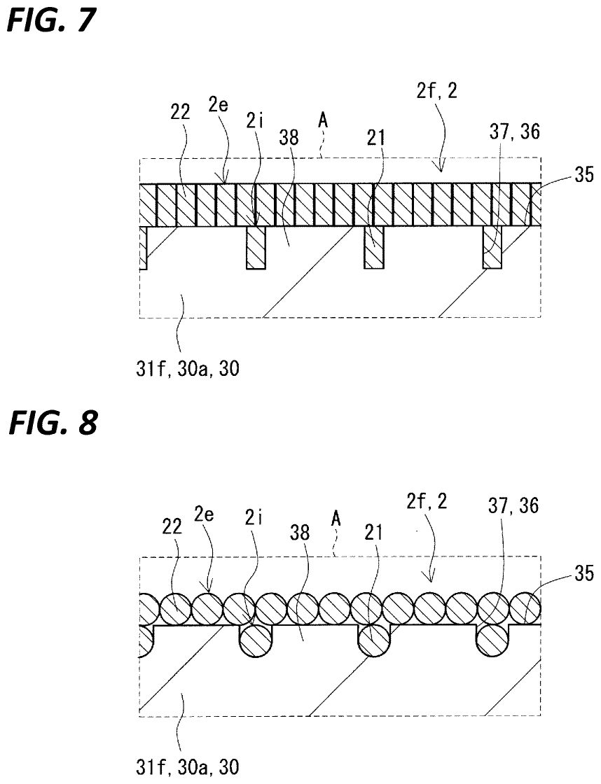

As shown in FIG. 7, a first winding portion 2i and a second winding portion 2e may be configured by winding a coated rectangular wire edgewise in the reactor of the second embodiment. If lengths of the first and second winding portions 2i, 2e in a direction along an axis are fixed, the first and second winding portions 2i, 2e wound edgewise tend to have more turns than the first and second winding portions 2i, 2e wound flatwise. If turn numbers of the first and second winding portions 2i, 2e are fixed, the lengths in the direction along the axis of the first and second winding portions 2i, 2e wound edgewise are more easily reduced than those of the first and second winding portions 2i, 2e wound flatwise. Thus, the first and second winding portions 2i, 2e wound edgewise are more easily reduced in size than the first and second winding portions 2i, 2e wound flatwise. In this embodiment, a width of each groove portion 36 is equal to a thickness of a first winding wire 21. A depth of each groove portion 36 is equal to a width of the first winding wire 21. Note that the depth of each groove portion 36 may be smaller or larger than the width of the first winding wire 21.

### Third Embodiment

As shown in FIG. 8, the contour shape of each groove portion 36 may be a U shape and a first winding wire 21 and a second winding wire 22 may be round wires in the reactor of the third embodiment. A width and a depth of each groove portion 36 are equal to a diameter of the first winding wire 21.

### Fourth Embodiment

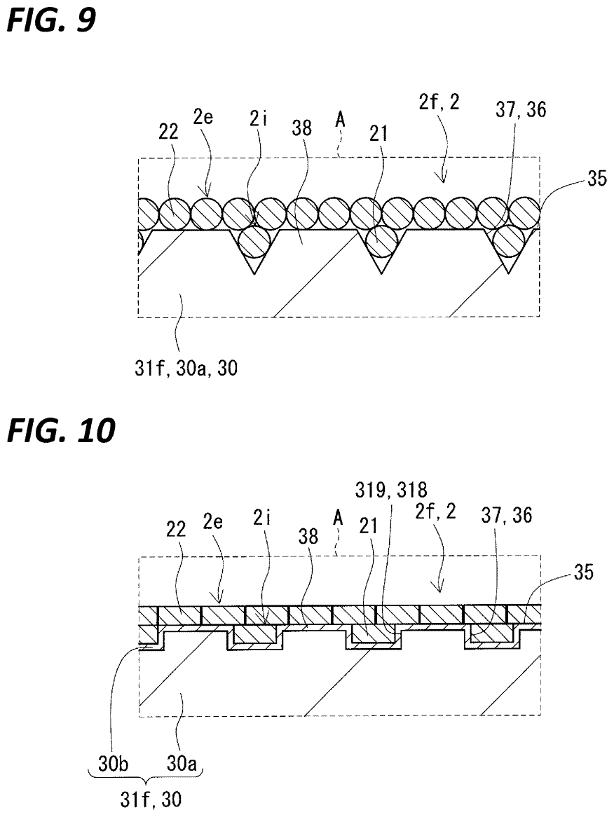

As shown in FIG. 9, the contour shape of each groove portion 36 may be a V shape and a first winding wire 21 and a second winding wire 22 may be round wires in the reactor of the fourth embodiment. An opening width of each groove portion 36 is larger than a diameter of the first winding wire 21, and a depth of each groove portion 36 is larger than the diameter of the first winding wire 21.

### Fifth Embodiment

As shown in FIGS. 10 and 11, a core portion 30 may include a core body portion 30a and an insulating portion 30b provided along the outer peripheral surface of the core body portion 30a in the reactor of the fifth embodiment. Insulation between the core body portion 30 and a coil 2 is easily enhanced by the insulating portion 30b. The core body portion 30a is constituted by the compact or the laminated body described above. The insulating portion 30b is, for example, made of resin similar to the resin of the compact of the composite material described above. The core body portion 30a and the insulating portion 30b of this embodiment are integrated. Unlike this embodiment, the core body portion 30a and the insulating portion 30b may be independent of each other.

The core body portion 30a of this embodiment has a rectangular prism shape. The outer peripheral surface of the core body portion 30a is composed of four flat surfaces and four corner parts.

As shown in FIG. 10, out of the four flat surfaces, at least one flat surface may include a plurality of groove portions 318 arranged in a direction along an axis of the core body portion 30a. Although not shown, the flat surface facing the flat surface provided with the plurality of groove portions 318, out of the four flat surfaces of the core body portion 30a, may also include a plurality of groove portions 318. Further, the remaining two flat surfaces of the core body portion 30a may also include a plurality of groove portions 318. Further, the four corner parts of the core body portion 30a may also include a plurality of groove portions 318. The outer peripheral surface of the core body portion 30a may include one helical groove 319 provided coaxially with the core body portion 30a.

As shown in FIG. 10, the insulating portion 30b has a first flat surface 35 provided with the plurality of groove portions 36 described above. The first flat surface 35 of the insulating portion 30b is provided to cover the flat surface(s) provided with the plurality of groove portions 318, out of the four flat surfaces of the core body portion 30a. The respective groove portions 36 are along the respective groove portions 318. Although not shown, the insulating portion 30b may be provided to cover the four corner parts of the core body portion 30a. If the plurality of groove portions 318 are provided also in the corner parts of the core body portion 30a, parts of the insulating portion 30b covering the corner parts of the core body portion 30a also include a plurality of groove portions 36. The respective groove portions 36 in the corner part of the insulating portion 30b are along the respective groove portions 318 in the corner part of the core body portion 30a. The insulating portion 30b may be provided to cover the outer peripheral surface of the core body portion 30a over an entire periphery. The outer peripheral surface of the insulating portion 30b may include one helical groove 37 described above. The helical groove 37 is provided coaxially with the insulating portion 30b. The helical groove 37 of the insulating portion 30b is along the helical groove 319 of the core body portion 30a.

Unlike the example shown in FIG. 10, any of the four flat surfaces and the four corner parts of the core body portion 30a may not include the plurality of groove portions 318 as shown in FIG. 11. That is, the core body portion 30a may not include the helical groove 319. The first flat surface 35 provided with the plurality of groove portions 36 in the insulating portion 30b is provided to cover the flat surface of the core body portion 30a. The outer peripheral surface of the insulating portion 30b may include one helical groove 37.

### Sixth Embodiment

Although not shown, a magnetic core may include a middle core portion, a first side core portion, a second side core portion, a first end core portion and a second end core portion in the reactor of the sixth embodiment. The middle core portion and the first and second side core portions are so arranged side by side that directions along axes thereof are parallel. The middle core portion is arranged between the first and second side core portions. The first side core portion is arranged to face a first end surface of the middle core portion, a first end surface of the first side core portion and a first end surface of the second side core portion. The second side core portion is arranged to face a second end surface of the middle core portion, a second end surface of the first side core portion and a second end surface of the second side core portion.

The magnetic core can be, for example, configured by combining an E-shaped first core piece and an I-shaped second core piece or combining a U-shaped first core piece and a T-shaped second core piece. The E-shaped first core piece is a compact or a laminated body in which a middle core portion, a first side core portion, a second side core portion and a first end core portion are integrated. The I-shaped core piece is constituted by a second end core portion. The U-shaped first core piece is a compact or a laminated body in which a first side core portion, a second side core portion and a first end core portion are integrated. The T-shaped core piece is a compact or a laminated body in which a middle core portion and a second end core portion are integrated.

In this embodiment, the core portion 30 described in the first embodiment may constitute each of the first and second side core portions. The aforementioned first coil 2f may be arranged on the outer periphery of the first side core portion, and the aforementioned second coil 2s may be arranged on the outer periphery of the second side core portion. The first and second coils 2f, 2s may be independent of each other.

### Seventh Embodiment

### Converter, Power Conversion Device

The reactor 1 of any one of the first to sixth embodiments can be utilized for applications satisfying the following energizing conditions. The energizing conditions are as follows. A maximum direct current is, for example, about 100 A or more and 1000 A or less. An average voltage is, for example, about 100 V or more and 1000 V or less. A use frequency is, for example, about 5 kHz or more and 100 kHz or less. The reactor 1 of any one of the first to sixth embodiments can be typically used as a constituent component of a converter to be installed in a vehicle 1200 such as a hybrid vehicle or a fuel cell vehicle or as a constituent component of a power conversion device provided with this converter.

The vehicle 1200 is, as shown in FIG. 12, provided with a main battery 1210, a power conversion device 1100 connected to the main body 1210 and a motor 1220 used for travel by being driven by power supplied from the main body 1210. The motor 1220 is, typically, a three-phase alternating current motor. The motor 1220 drives wheels 1250 during travel and functions as a generator during regeneration. In the case of a hybrid vehicle, the vehicle 1200 includes an engine 1300 in addition to the motor 1220. FIG. 12 shows an inlet as a charging point of the vehicle 1200, but the vehicle 1200 may include a plug.

The power conversion device 1100 includes a converter 1110 and an inverter 1120. The converter 1110 is connected to the main battery 1210. The inverter 1120 is connected to the converter 1110. The inverter 1120 performs the mutual conversion of a direct current and an alternating current. The converter 1110 shown in this example steps up an input voltage of the main battery 1210 of about 200 V or more and 300 V or less to about 400 V or more and 700 V or less and supplies the stepped-up voltage to the inverter 1120 during the travel of the vehicle 1200. The converter 1110 steps down an input voltage output from the motor 1220 via the inverter 1120 to a direct-current voltage suitable for the main battery 1210 and charges the main battery 1210 with the direct-current voltage during regeneration. The input voltage is a direct-current voltage. The inverter 1120 converts the direct current stepped up by the converter 1110 into a predetermined alternating current and supplies the converted current to the motor 1220 during the travel of the vehicle 1200. The inverter 1120 converts an alternating current output from the motor 1220 into a direct current and outputs the direct current to the converter 1110 during regeneration.

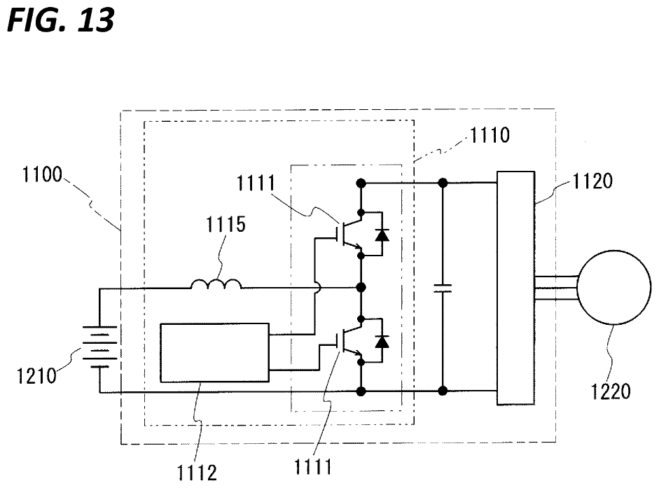

The converter 1110 includes a plurality of switching elements 1111, a drive circuit 1112 for controlling the operation of the switching elements 1111 and a reactor 1115 as shown in FIG. 13. The converter 1110 converts an input voltage by being repeatedly turned on and off. The conversion of the input voltage means voltage step-up and -down here. A power device such as a field effect transistor or an insulated gate bipolar transistor is used as the switching element 1111. The reactor 1115 has a function of smoothing a change of a current when the current is increased or decreased by a switching operation, using a property of a coil to hinder a change of a current flowing into a circuit. Any one of the reactors 1 of the first to sixth embodiments is provided as the reactor 1115. The power conversion device 1100 and the converter 1110 provided with the reactor 1 can be expected to improve heat dissipation without being enlarged.

Besides the converter 1110, the vehicle 1200 is provided with a power supply device converter 1150 and an auxiliary power supply converter 1160. The power supply device converter 1150 is connected to the main battery 1210. The auxiliary power supply converter 1160 is connected to a sub-battery 1230 and the main battery 1210 serving as power sources of auxiliary devices 1240. The auxiliary power supply converter 1160 converts a high voltage of the main battery 1210 into a low voltage. The converter 1110 typically performs DC-DC conversion, but the power supply device converter 1150 and the auxiliary power supply converter 1160 perform AC-DC conversion. The power supply device converter 1150 may perform DC-DC conversion. Reactors configured similarly to the reactor 1 of any one of the first to sixth embodiments and appropriately changed in size, shape and the like can be used as reactors of the power supply device converter 1150 and the auxiliary power supply converter 1160. Further, the reactor 1 of any one of the first to sixth embodiments or the like can also be used in a converter for converting input power and only stepping up a voltage or only stepping down a voltage.

The present invention is not limited to these illustrations, but is represented by claims and intended to include all changes in the scope of claims and in the meaning and scope of equivalents.

### LIST OF REFERENCE NUMERALS

1 reactor
2 coil, 2f first coil, 2s second coil,
2i first winding portion, 2e second winding portion
21 first winding wire, 22 second winding wire
3 magnetic core, 30 core portion
30a core body portion, 30b insulating portion
31f first middle core portion, 31s second middle core portion
318 groove portion, 319 helical groove
33f first end core portion, 33s second end core portion
35 first flat surface, 36 groove portion, 37 helical groove, 38 ridge
1100 power conversion device, 1110 converter
1111 switching element, 1112 drive circuit, 1115 reactor
1120 inverter
1150 power supply device converter, 1160 auxiliary power supply converter
1200 vehicle
1210 main battery, 1220 motor, 1230 sub-battery
1240 auxiliary devices, 1250 wheel
1300 engine

1. A reactor, comprising:
a magnetic core including a core portion configured into an angular prism shape; and
a coil including a first winding portion arranged an outer periphery of the core portion and a second winding portion arranged on an outer periphery of the first winding portion,
the first winding portion being formed by a first winding wire helically wound along an outer peripheral surface of the core portion,
the second winding portion being formed by a second winding wire helically wound along an outer peripheral surface of the first winding portion,
the first winding wire and the second winding wire constituting a continuous winding wire,
a turn number of the first winding portion is less than a turn number of the second winding portion,
the outer peripheral surface of the core portion including a first flat surface having a plurality of groove portions arranged in a direction along an axis of the core portion, and
a part of the first winding wire in each turn of the first winding portion being arranged in each of the plurality of groove portions.

2. The reactor of claim 1, wherein:
the outer peripheral surface of the core portion includes a helical groove provided coaxially with the core portion,
each of the plurality of groove portions constitutes a part of the helical groove, and
the first winding wire in all the turns of the first winding portion is arranged in the helical groove.

3. The reactor of claim 1, wherein a depth of each of the plurality of groove portions is equal to a length along a direction of the depth in a cross-section of the first winding wire.

4. The reactor of claim 1, wherein a depth of each of the plurality of groove portions is smaller than a length along a direction of the depth in a cross-section of the first winding wire.

5. The reactor of claim 1, wherein a depth of each of the plurality of groove portions is larger than a length along a direction of the depth in a cross-section of the first winding wire.

6. The reactor of claim 1, wherein:
the first winding wire and the second winding wire are rectangular wires, and
a cross-sectional shape of each of the plurality of groove portions cut along the axis of the core portion is a rectangular shape.

7. The reactor of claim 6, wherein the first winding portion and the second winding portion are formed by winding the rectangular wire flatwise.

8. The reactor of claim 6, wherein the first winding portion and the second winding portion are formed by winding the rectangular wire edgewise.

9. The reactor of claim 1, wherein:
the core portion has a rectangular prism shape, and
the first winding portion and the second winding portion have a rectangular tube shape.

10. The reactor of claim 1, wherein:
the core portion includes a core body portion mainly containing a magnetic material and an insulating portion provided along an outer peripheral surface of the core body portion, and
the plurality of groove portions are provided in the insulating portion.

11. A magnetic core, comprising a core portion having an angular prism shape,
an outer peripheral surface of the core portion including a first flat surface having a plurality of groove portions arranged in a direction along an axis of the core portion.

12. The magnetic core of claim 11, wherein:
the outer peripheral surface of the core portion includes a helical groove provided coaxially with the core portion, and
each of the plurality of groove portions constitutes a part of the helical groove.

13. A converter, comprising the reactor of claim 1.

14. A power conversion device, comprising the converter of claim 13.
